(19) United States
(12) Patent Application Publication
(10) Pub. No.: US 2014/0354540 A1
(43) Pub. Date: Dec. 4, 2014

(54) SYSTEMS AND METHODS FOR GESTURE RECOGNITION

(71) Applicant: Khaled Barazi, Waltham, MA (US)

(72) Inventor: Khaled Barazi, Waltham, MA (US)

(21) Appl. No.: 14/293,455

(22) Filed: Jun. 2, 2014

Related U.S. Application Data
(60) Provisional application No. 61/830,351, filed on Jun. 3, 2013.

(51) Int. Cl. G06F 3/01

(52) U.S. Cl. CPC G06F 3/017
USPC 345/156

(57) ABSTRACT

According to various aspects, systems and methods are disclosed for the implementation of a touch-free, gesture based user interface for mobile computing systems. Aspects of the system describe components used for capturing digital video frames from a video stream using the native hardware of the mobile computing system. Further aspects of the system describe efficient object recognition and tracking components capable of recognizing the motion of a defined model object. Various aspects of the disclosed system provide systems and processes for associating the recognized motion of a model object with a gesture, as well as associating the gesture with a user interface operation.

### CROSS REFERENCE TO RELATED APPLICATIONS

This application claims priority under 35 U.S.C. §119(e) to U.S. Patent Application Ser. No. 61/830,351 entitled “SYSTEMS AND METHODS FOR GESTURE RECOGNITION”, filed on Jun. 3, 2013 which is herein incorporated by reference in its entirety.

### BACKGROUND

1. Technical Field

Embodiments disclosed herein relate generally to systems and methods of gesture recognition and, more particularly, to systems and methods for image capture, image processing, and image recognition for the processing of gestures from a mobile computing device.

2. Discussion of Related Art

The triggering of computer operations based on keypad entry and touchscreens embedded in computer devices have become de-facto standards in the mobile computing industry. Touch screens are now commonly used alongside more traditional voice controlled operations of mobile telephone systems. To perform input operations for the majority of mobile devices, and mobile operating systems, users must often be either in physical contact with the device or within audio range of the device's microphone.

Some conventional approaches have attempted to incorporate the use of motion tracking for the control of computer interface operations. For example, gesture detection has been incorporated into certain peripheral computer devices, most notably the Kinect sensor from Microsoft Corporation, of Redmond, Wash. While peripheral computing devices have previously provided capabilities for object detection and motion tracking, these existing peripheral computing devices have not been native, and generally involve customer hardware and software solutions.

### SUMMARY

According to some aspects of the present invention, a mobile computing system is provided. The mobile computing system is configured to recognize an object within a digitally captured image from a video stream and to perform user interface operations based on the tracking of that object. Object recognition and tracking can be performed using native hardware in such a manner that user interface operations can be updated in real time on the mobile computing device. In some embodiments, the mobile computing systems include known mobile devices, such as iPhone®, iPad®, iPad Mini, and iPod® Touch devices from Apple Computer of Cupertino, Calif. or mobile devices executing the Android™ operating system from Google, Inc. of Mountain View, Calif. According to one embodiment, the mobile computing system leverages native hardware and sensors to provide capabilities for digital image capture and digital image processing. In one example, a user can download and execute an associated software application to provide gesture detection through native capabilities on the mobile device. Aspects of the disclosure provide systems and processes for delivering instructions to a user on performing recognizable gestures. Further aspects of the disclosure provide for efficient storage of captured image data, as well as methods for efficiently recognizing and tracking a model object within the frames of a video stream. Various embodiments of the disclosed system provide for different methods of defining a model object. In some embodiments, the system can receive a model object definition as provided by the user. In further embodiments, a pre-stored database of model objects can be utilized. In other embodiments, the detection of a series of geometric relationships applied to captured geometric forms can be recognized as a model object. Still further aspects of the disclosed system provide for integration of the object image tracking system with a mobile computer operating system in order to provide for a gesture recognition computer user interface. Various embodiments are configured to receive user instructed commands based on user motion captured by the frames of a video stream.

According to various aspects of the present invention, it is appreciated that most mobile devices have limited processing and/or memory resources that are available for performing image processing. Therefore, according to various embodiments described herein, techniques are provided to enable a mobile device to perform efficiently gesture recognition and associated operations. Further, according to various embodiments, such capabilities are provided using the native camera and native processing capabilities of the device without the need for specialized hardware.

Various aspects of the present invention provide functionality allowing users of portable computing devices with mobile applications, as well as desktops and laptop computing devices with installed software, to control partially or fully those devices without touching the display or any other medium of the devices normally required to be touched to produce certain actions.

According to at least one aspect, a system for providing a gesture based user interface is described. The system for providing a gesture based user interface includes a memory, at least one processor operatively coupled to the memory, a display device coupled to the at least one processor, at least one native digital camera coupled to the at least one processor that can be configured to associate the tracking of objects with user interface operations.

In the system providing a gesture based user interface the at least one native digital camera can be configured to capture digital video, and the captured digital video can be displayed with the center of the field of view captured by the at least one digital camera aligned to the center of the display device. In addition, the object tracking component of the system for providing a gesture based user interface can be further configured to define a model object boundary location for display on the display device.

Furthermore, the system providing a gesture based user interface may further comprise a training component configured to provide instruction to a user on placement of a model object in relation to the model object boundary location. Moreover, the training component can be further configured to provide user instruction that a proper model object can be obtained by the native digital camera. Additionally, the model object boundary location can be displayed on the display device simultaneously with the digital video. In addition, the object tracking component can be configured to capture digital video data of a model within the model object boundary location. Also, the object tracking component can be configured to define the model object from captured digital video data. Further, the object tracking component can be configured to define the model object from captured digital video data.

The system providing a gesture based user interface can be configured such that the object tracking component is further configured to define a digital image of a model object. In addition, the processor of the system can be further configured to perform edge detection on the digital image of the model object to obtain an edge image of the model object. Moreover, the processor of the system can be further configured to perform edge detection with a Canny edge detection process. Additionally, the processor can be further configured to use luminance-based upper and lower thresholding limits within the Canny edge detection process. Furthermore, those upper and lower threshold limits can be set dynamically. In addition, the memory of the system can be further configured to store edge pixel row indices and column indices for the model object in a densely packed form.

Moreover, the object tracking component of the system can be further configured to search for a matching object within a digital video frame of a streaming digital video via a raster scan of the frame. Furthermore, the raster scan can be performed using a window of the same size as the model object image. Additionally, the processor of the system can be further configured to perform edge detection of objects present in successive raster scan window locations. Further, the memory of the system can be further configured to reuse addressable locations that were allocated for performing edge detection on the image of the model object when performing edge detection on the sliding window of the raster scan. Moreover, the processor of the system can be further configured to perform edge detection via a Canny edge detection process. In addition the processor can be configured to use luminance-based upper and lower threshold limits within the Canny edge detection process. Furthermore, the upper and lower threshold limits can be set dynamically. Additionally, the memory of the system can be further configured to store edge pixel row indices and column indices of objects within the raster scan window in a densely packed form.

Further, the processor of the system can be further configured to count the number of edge pixels within the window of the raster scan and the number of pixels within the model to determine if the counts are within a predefined threshold limit of each other. Moreover, the processor can be further configured to count the number of edge pixels within the window of the raster scan and the number of pixels within the window of the raster scan at the same location within a previous frame to determine if the counts are within a predefined threshold limit of each other.

Additionally, the object tracking component of the system can be further configured to match a model object with an identified second object in the raster scan window via a Hausdorff distance metric calculation process. Furthermore, the object tracking component can be further configured to consider as matches only an object in the raster scan window where half the constituent edge pixels are less than two pixels apart. Furthermore, the object tracking component can be further configured to exit the raster scan process without completing the entire raster scan based on second level thresholding criteria.

In some aspects, the system for providing a gesture based user interface can further comprise a database of gestures. Additionally, the object tracking component of the system can be further configured to match a model object to a second object within temporally successive video frames. Moreover, the processor of the system can be further configured to identify the tracked object within temporally successive video frames as a gesture from the database of gestures. Additionally, the processor can be further configured to associate an identified gesture with a user interface operation displayed on the display device. Furthermore, the object tracking component of the system can be further configured to recognize the gesture using a subset of image data within a video frame based on matching a model object at a trigger location. Also, the object tracking component can be further configured to recognize a selection gesture as matching a model object at a single spatial trigger location for a predefined number of temporally successive video frames. In addition, the object tracking component can be further configured to recognize a swipe gesture as matching a model object in spatially successive adjacent locations from a trigger location within temporally successive video frames. Moreover, the processor can be further configured to update the position of a pointer displayed on the display device in relation to the location of a tracked object in temporally successive video frames.

According to at least one aspect, a method for performing computer user interface operations is provided. The method includes acts of capturing a digital video, displaying captured digital video on a display device, identifying a model object within a first video frame, tracking a model object by matching objects within successive video frames, associating the location of a model object in successive video frames with a gesture, associating a gesture with a user interface operation, and executing a user interface operation.

In the method, the act of capturing the digital video may include the use of at least one native digital camera integrated into a computer to capture the digital video. In addition, the act of displaying the captured digital video on the display device may further include aligning the center of the captured video with the center of the display device. Furthermore, the act of identifying a model object may further include defining a model object boundary location for display on the display device. Additionally, the act of identifying the model object may further include providing instruction to a user on placement of the model object in relation to the model object boundary location. Also, the act of identifying the model object may further include displaying the model object on the display device simultaneously with the digital video. In addition, the act of identifying the model model object may further include capturing digital video data of a model object within the model object boundary location. In addition, the act of identifying the model object further comprises defining the model object from the captured digital video data.

The method may also include the tracking of the model object whereby the tracking further comprises performing edge detection on the digital image of the model object to obtain an edge image of the model object. Furthermore, the act of tracking of the model object may also include performing Canny edge detection on the digital image of the model object. Also, the act of tracking the model object may also include using luminance-based upper and lower threshold limits within the Canny edge detection process. Moreover, the act of setting threshold limits within the Canny edge detection process may also be set dynamically.

In further aspects, the method may also include tracking the model object whereby the tracking may include storing edge pixel row indices and column indices for the model object in a densely packed form. Additionally, the method may also include tracking the model object whereby the tracking may also include searching for a model object within a digital video frame of a streaming digital video via a raster scan of the frame. Furthermore, the act of of tracking the model object may also include performing a raster scan using a window of the same size as the model object image. Also, the act of tracking the model object may also include performing edge detection of objects present in successive raster scan window locations. Moreover, the act of tracking the model object may also include reusing addressable memory locations for performing edge detection on the sliding window of the raster scan that were previously used for performing edge detection on the image of a model object. Further, the act of tracking the model object may also include performing edge detection via a Canny edge detection process. Additionally, the act of tracking the model object may also include using luminance based upper and lower threshold limits within the Canny edge detection process. Also, the act of setting upper and lower threshold limits may be set dynamically.

According to another aspect, the method may also include tracking the model object whereby the tracking also includes using memory to store edge pixel row indices and edge pixel column indices of objects within the raster scan window in a densely packed form. Additionally, the act of tracking the model object may also include counting the number of edge pixels within the window of the raster scan and the number of edge pixels within the model object to determine if the counts are within a predefined threshold limit of each other. Moreover, the act of tracking the model object may also include matching a model object with an identified second object in the raster scan window via a Hausdorff distance metric calculation process. Furthermore, the act of tracking the model object may also include determining as a match of the model object only objects within the raster scan window where half the constituent edge pixels are less than two pixels apart.

In additional aspects, the method may also include associating the location of a model object in successive video frames with a gesture, whereby the association may include comparing a detected sequence of matched object locations with entries in a database of gestures. Moreover, the act of associating the location of a model object in successive video frames with a gesture may also include recognizing the gesture. Addtionally, the method may also include recognizing the gesture using a subset of image data within the video frame based on matching the model object at a trigger location. Furthermore, the method may also include recognizing a selection gesture as matching the model object at a location for a predefined number of temporally successive video frames. In addition, the act of associating the gesture with a user interface operation may also include associating the gesture with a selection user interface operation. Also, the act of executing the user interface operation may also include executing the selection operation.

In various aspects, the method may also include recognizing a swipe gesture as matching the model object in spatially successive adjacent locations within temporally successive video frames. In addition, the act of associating the gesture with a user interface operation may also include associating the gesture with a swipe user interface operation. Furthermore, the act of executing the user interface operation may also include executing the swipe operation.

In further aspects, the method may also include updating the position of a pointer displayed on the display screen in relation to the location of a tracked object in temporally successive video frames. Furthermore, the act of associating the gesture with a user interface operation may also include associating the gesture with a pointer movement user interface operation. Additionally, the act of executing the user interface operation may also include executing the pointer movement operation.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates an external view of a mobile computing device incorporating a touch screen display and a camera upon which various aspects in accord with the present invention may be implemented;

FIG. 2 illustrates a logical diagram of an image capture and gesture recognition system;

FIG. 3 illustrates an example digital image captured by the camera of a mobile computing device according to an embodiment;

FIG. 4 illustrates an example graphical representation of a mobile computing device screen display highlighting a central trigger location for capturing a model object;

FIG. 5 illustrates an example digital image resulting from an edge detection operation according to an embodiment;

FIG. 6 illustrates example edge images used as the basis for a distance metric calculation according to an embodiment;

FIG. 7 illustrates an example graphical representation of a mobile computing device screen display highlighting side trigger locations for capturing a model object;

FIG. 8A-FIG. 8D illustrate example graphical representations of performing a raster scan to detect a match of a model object within a video frame;

FIG. 9 displays a method for object tracking when using a single model object capture and distance metric calculation;

FIG. 10 displays a method for gesture detection when using a single model object capture and repetitive target matching and distance metric calculations;

FIG. 11 displays a method for performing edge detection using a modified Canny edge detection process;

FIG. 12 illustrates a data layout representing the locations of edge and non-edge points within a digital image;

FIG. 13 illustrates a compressed data layout representing only the edge point locations within a digital image;

FIG. 14 displays a method for performing distance metric calculations; and

FIG. 15 illustrates an example computer system upon which various aspects in accord with the present invention may be implemented.

### DETAILED DESCRIPTION

For the purposes of illustration only, and not to limit the generality, the present disclosure will now be described in detail with reference to the accompanying figures. This disclosure is not limited in its application to the details of construction and the arrangement of components set forth in the following description or illustrated in the drawings. The principles set forth in this disclosure are capable of other embodiments and of being practiced or carried out in various ways. Also the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Various embodiments of the present disclosure are directed to systems and methods for detecting and processing gestures using native hardware on a mobile computing device (e.g. a front-facing camera). In some embodiments, an appropriate software application can be downloaded, installed, and executed to leverage the native camera device into gesture detection user interface displays. Embodiments disclosed herein are directed to techniques for performing digital image capture and image processing that provide functionality for a gesture tracking computer user interface. Some aspects provide training to a user on the placement of objects within a field of view of a native camera for a mobile device, as well as capability for detecting objects within the field of view of a native camera. In some embodiments, the system is configured to operate within a sub-section of a camera's field of view. Limiting detection to a specified sub-section can improve performance and enable faster response time to user gesture.

Further aspects of the disclosure provide methods for identifying specific model objects within frames of a captured digital video stream, as well as utilizing a model object as basis for tracking the motion of an object through space and in time. In some embodiments, the system can detect the model object provided by a user. In other embodiments, the system can maintain a pre-stored set of potential model objects within a database installed on the device. In further embodiments, the system can define the model object as a set of geometric relationship conditions between shapes that are detected within a captured video frame. Particular aspects of the disclosure provide for storage of data and execution of operations in a real-time manner leveraging the hardware capabilities of a mobile computing system.

The systems and methods further enable execution of a set of rules associating the tracking of particular gesture types with operations to be performed by a mobile computer operating system. For example, by analyzing video taken by a native camera, the system can identify specific gestures, such as swiping, pointing, rotating, pinching, twisting, as well as fine-grained continuous motion tracking. In some embodiments, the system can include a gesture database and an execution engine that maps specific gestures to user interface functionality. In some embodiments, a gesture database may contain data structures that include associations between the detected gestures and the context of particular application or operating system operations.

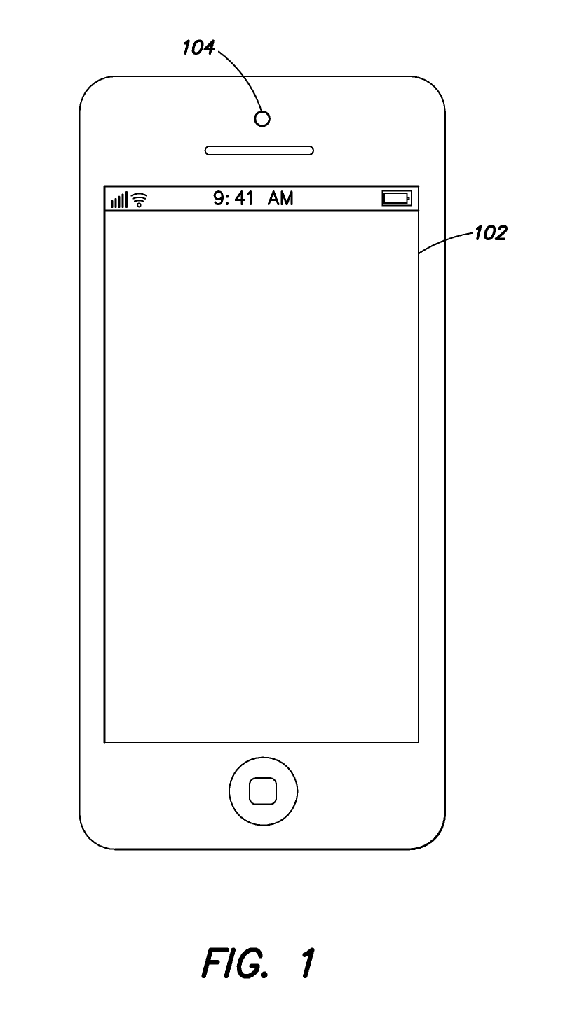

FIG. 1 schematically illustrates an external view of a mobile computing device indicated at 100, according to one embodiment of the present disclosure. The mobile computing device 100 incorporates a display 102 with capacitive touch-screen capabilities, as well as an embedded camera 104 configured to capture digital video. Examples of mobile computing devices may include cellular phones, tablets, portable music players, portable gaming devices, as well as various types of “smart phones” or “smart watches,” or any other mobile device capable of capturing image data. In one embodiment, the native camera 104 is a forward facing camera located on the same side of the mobile computing device as the display screen. In another embodiment, the native camera is located on the rear side of the mobile computing device opposite the display screen. In some embodiments, the mobile computing device might include more than one native camera located on both the front and back sides of the mobile computing device. In some embodiments, the embedded native camera can collect video image data within its field of view to be processed by the mobile device for display on the display device as described in more detail below.

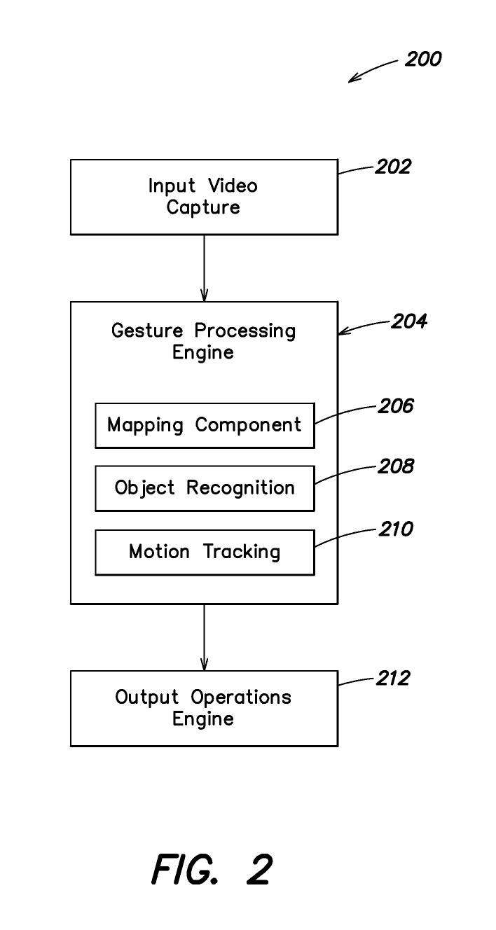

FIG. 2 illustrates a logical component process 200 associating an input video stream 202 captured by the native camera 104 of a mobile computing device 100, with a gesture detection processing engine 204 configured to execute particular video operations (e.g. digital image processing operations), and an output operations engine 212 configured to execute contextual user interface operations. In some embodiments, the processing engine 204 includes a mapping component 206 configured to position video data captured by the native camera to be aligned to the display device such that the center of the camera's field of view is aligned with the center of the display device.

In further embodiments, the processing engine 204 may also include an object definition and recognition component 208 configured to define a model object of interest within an image using image definition, edge detection, and distance metric calculation techniques described in more detail below. In some embodiments, the process of image definition may utilize a pre-existing model object, such as a model object provided by the user or a pre-stored model object from a database of model objects. In other embodiments, the process of image definition may utilize object recognition by applying a set of rules for the geometric relationships between detected geometric forms, as described in more detail below. In particular embodiments, the gesture detection processing engine 204 may also include a motion tracking component 210 configured to identify instances of, or likely instances of, a model object through various frames of a streaming video feed. In one implementation, the object tracking component can use image definition, edge detection, and distance metric calculation techniques described in more detail below. Each of these components of the gesture detection processing engine 204 may play a role in identifying gestures performed by a user that are captured by the native camera 104 within frames of a digital video stream.

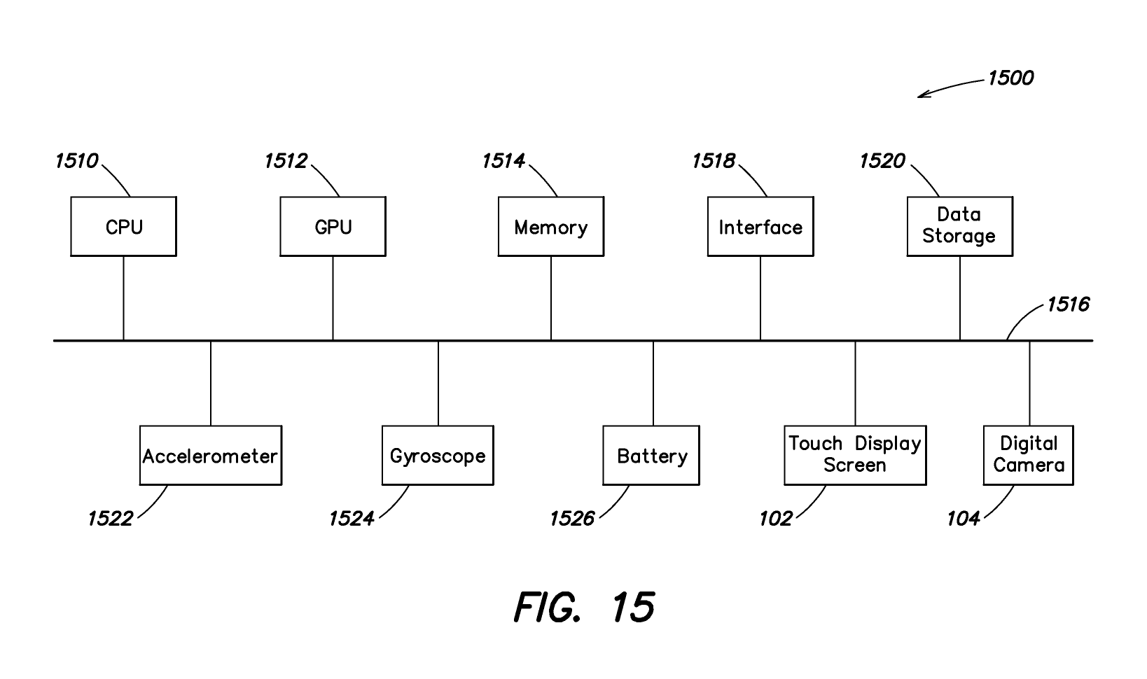

In some implementations, a gesture detection system can accept video capture input 202. The system can process the input 202 to identify pre-defined objects using gesture detection processing engine 204. The gesture detection processing engine 204 can translate tracked motion of the model object from input 202 into a user interface operation to be executed by an output operations engine 212. In some embodiments, the system can be implemented on a general purpose computer, including, for example, mobile computing devices as described below with reference to FIG. 15. The gesture detection processing engine 204 can be executed on the general purpose computer 1500 to provide a gesture recognition user interface system. Specific components, processes and subprocesses of the gesture recognition system are described further below.

### Image Capture and Image Processing

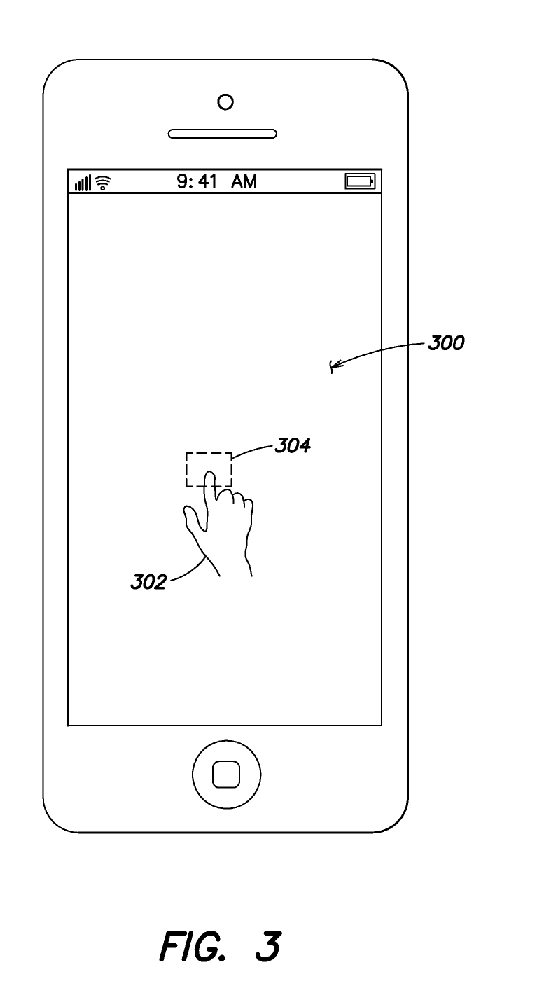

With reference to FIG. 3, a digital image 300 from a video feed may be captured by the digital camera 104 embedded within the mobile computing device 100. In one example, the captured digital image includes output measurements of an array of sensors with the measurement of performed by each sensor in the array representing a single pixel in the digital image. The values stored for each pixel might be a binary value of 0 or 1 for images that are purely black or white. In other examples, the values stored for each pixel may have a numerical range for images that are represented in a grayscale. In some embodiments, each pixel may consist of an array of values representing the color of light detected at a particular pixel. In such cases, the image may be represented using a standard RGB, RGBA, CIE, HSV, HSL, YCBCr, or Y′CbCr color model, which is stored in the computer random access memory or a permanent data storage element of the mobile computer. The digital image 300 can contain objects 302 that are within a field of view of the camera 104, and are represented by areas of the image that may be uniform or mostly uniform in color or luminance and demarcated by edges between areas of separate color or luminance. In one embodiment, image data can be stored in any of the formats above and transformed into “edge images” using various techniques discussed in greater detail below. Edge images provide object outline information used to detect and track objects, for example model objects or objects detected within real time scanning of a video frame.

In some embodiments, the present disclosure provides a method for capturing and identifying a model object within an initial image, as well as identifying and tracking shapes that are likely matches of the model object within subsequently captured images. According to one embodiment, the system captures a plurality of digital images over time (e.g. image 300). The system is configured to identify, for example, the user's finger at 304 from the image. The system tracks the motion of the user's finger through successive images and associates the motion with a gesture.

In other embodiments, the system can utilize a pre-stored database of potential model objects. In these embodiments, the system can identify and track shapes that are likely matches of pre-stored model objects from within the database of potential model objects. For example, models of potential user fingers or hands may be pre-stored in a database and used as model objects.

In further embodiments, the system can perform real-time object recognition without the need for a pre-defined model object by executing rules that associate geometric relationships of detected geometric forms as model objects to be tracked. For example, the system could detect an object closely resembling two nearby lines with a preset maximum angle at a location where they would join if extended and those lines connected by a semi-circle. In this example, the system could associate the detected shape as being the user's finger.

In some embodiments, the system can reference a database of gestures and associated operations to map specific gestures to user interface operations. In further embodiments, gesture/operation entries can include contextual associations (e.g. a current operation system context, a current application context, etc.) and the system can select an operation according to a gesture and a context. According to one embodiment, a gesture recognition system is configured to train a user to employ gesture recognition. The system defines a model object through user interaction, as described in more detail below.

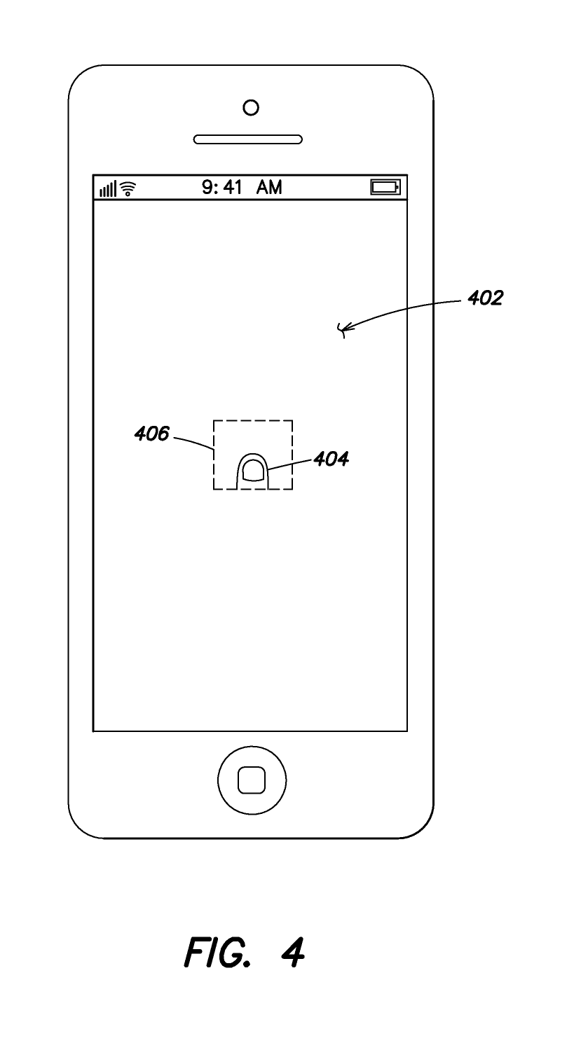

FIG. 4 illustrates a display screen 102 displaying an image 402 containing a model object 404. To capture the model object 404 for use as a reference object when processing future images, a rule is executed by the central processor and graphics processor of the mobile computing device to display a target location 406 within the image displayed on the display screen 402. In addition displaying the target location 406 on the display device 102, as part of one embodiment, the central processor can issue instructions to the graphics processor to display a real-time video of the images captured by the native camera 104 on the display screen 102. The image captured by the native camera 104 can be stored within an image buffer associated with the native camera. In some embodiments, when copying the data stored within the image buffer of the camera to the image buffer of the display screen, the data can be aligned such that the center of image buffer of the native camera is aligned to the center of the image buffer of the display device. In these embodiments, the user can be presented with an effective a real-time mirror image of the actions occurring in front of the display device 102. Aligning to the center of the display screen can also maintain a consistent experience when implemented on display devices having different resolutions. By displaying a mirror image of the user's actions in front of the display device, a user provided model object can be easily aligned with a desired target location for capturing the model object as shown in FIG. 4.

In some embodiments, upon displaying an effective mirror image 402 on the display device 102, and then overlaying a target location 406 on the image displayed on the display device, instructions may be provided to the user to orient an object 404, such as a finger, in a position within the boundaries of the target location 406. In further embodiments, the mobile computer may receive a command, which may be a button or key press, a voice command, a physically actuated command, or the use of a timer associated with a detecting an object in a location for a pre-defined time period, that instructs the mobile computer to capture in random access memory or permanent data storage the digital image 402 displayed on the display device for later use as a reference.

After obtaining a reference image, an edge detection process, such as a modification of the well-known Canny algorithm described in more detail below, may be used to identify the boundaries of the model object 404 obtained within the reference image. In some embodiments, the model object's edges can be used as a reference for the detection of similar objects in images obtained at a later time, such as video frames captured from a streaming video source.

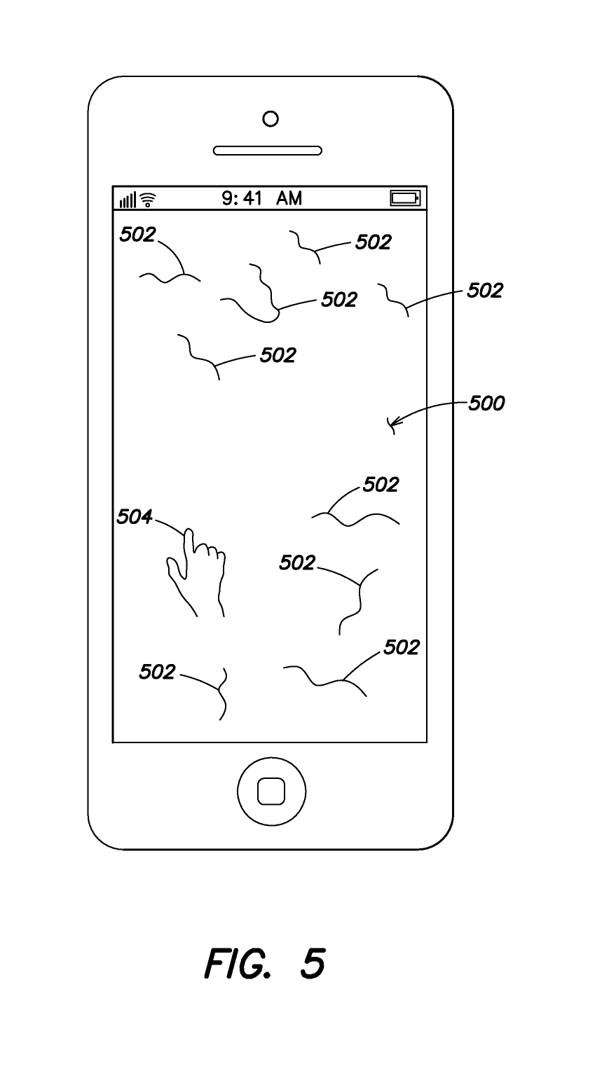

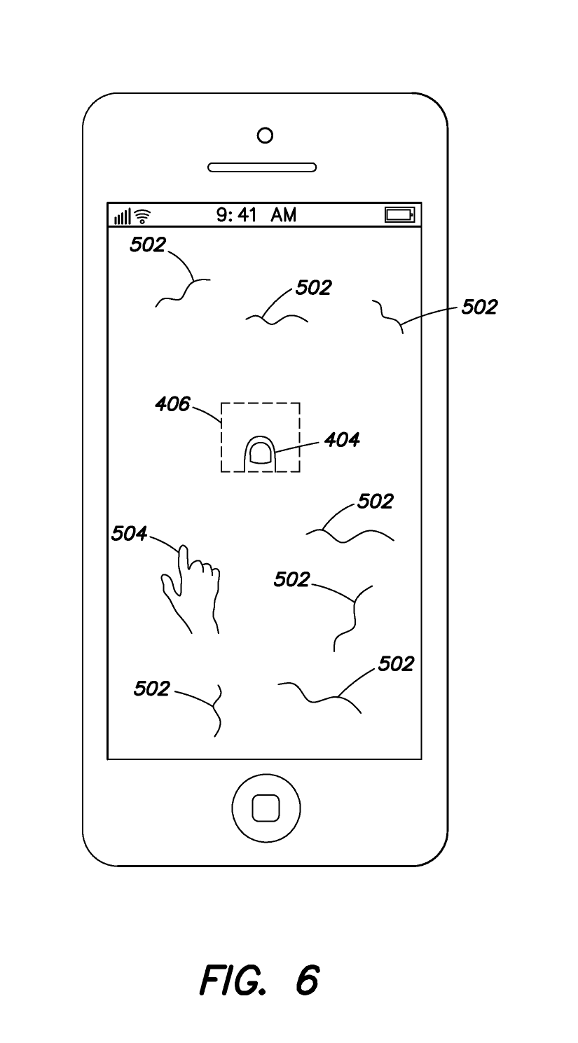

According to one embodiment, the embedded native camera 104 of the mobile computing device 100 can be configured to capture successive video frames as a video stream. These video frames can be displayed in real time on the display device 102. As shown in FIG. 5, an edge detection algorithm, such as a modified version of the Canny algorithm described later in this disclosure, can be utilized to process the edges for all objects present within the successive image frames of a real-time video. Contained within the detected “edge image” 500 might be a number of edges 502 that represent seemingly random objects within the field of view of the camera 104, as well as an object 504 that could potentially be a match of the reference object 404 captured previously. FIG. 6 illustrates the same “edge image” 500 with the reference object 404 and the original target location 406 also displayed on the display screen 102. In one example, a method is described below for identifying an object 504 that is a potential match of the reference object 404 using a modified version of the well known Hausdorff distance metric calculation.

In some embodiments, the identification of an object 504 that matches a reference object 404, allows for the processor of the mobile computing device to determine the relative location of the target object 504 in relation to the display device 102. By recognizing the physical location of an identified target object 504 in relation to the display device 102, the processor may execute rules that correlate position of the matching object 504 with a gesture defined within a gesture database. The processor updates the image displayed on the display device 102 based on rules associated with the observed gesture as stored in the gesture database. Examples of actions that a central processor may associate with recognizing a target object 504 might include selection of an item from a menu of items currently displayed on the display device 102, virtual color deposition on certain areas of an image displayed on the display device 102 as part of a virtual painting application, key press selection of a particular key within a virtual keyboard that is displayed on the display screen 102, as well as many other operations which may be associated with detection of a target object at a particular point in space. In some examples, such as a virtual keyboard application, an application might make use of an embedded camera that is on either the front-facing display-side or rear-facing back-side of the mobile computing device. In an example using a rear-facing camera, an image of a virtual keyboard can be displayed on the display screen along with a transformed image of the field of view of the rear facing camera. A user might then see a keyboard projected in space as part of the displayed image, and the tracking of finger movements as model objects can be associated with pressing virtual keys on the projected keyboard.

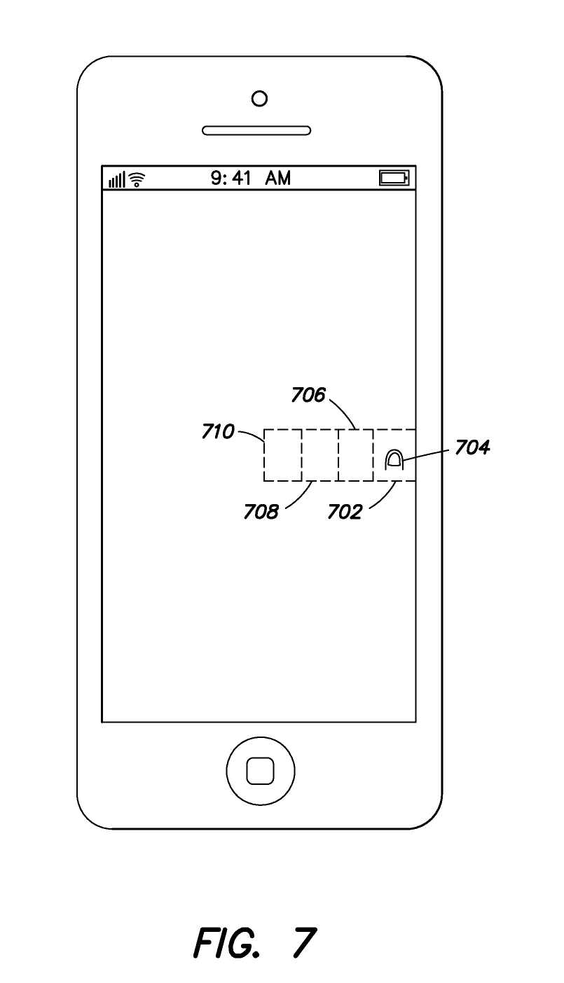

In some embodiments, as shown in FIG. 7, the trigger location 702 for capturing a model object 704 may be placed in a particular location on the screen, such as the screen edge. In further embodiments, the act of capturing subsequent target objects within subsequent images might be limited to particular areas 704, 706, 708 surrounding the initial model trigger location. In these embodiments, the system may attempt to detect, by a combination of edge detection and distance metric calculations as described in more detail below, instances of the target object being present within a successive series of images at each of the specified areas surrounding the initial trigger location 702. By detecting a series of closely adjacent instances of the model object 704, the system can interpret the action as a swipe that has been performed by the user in relation to a specific location in front of the display screen 102.

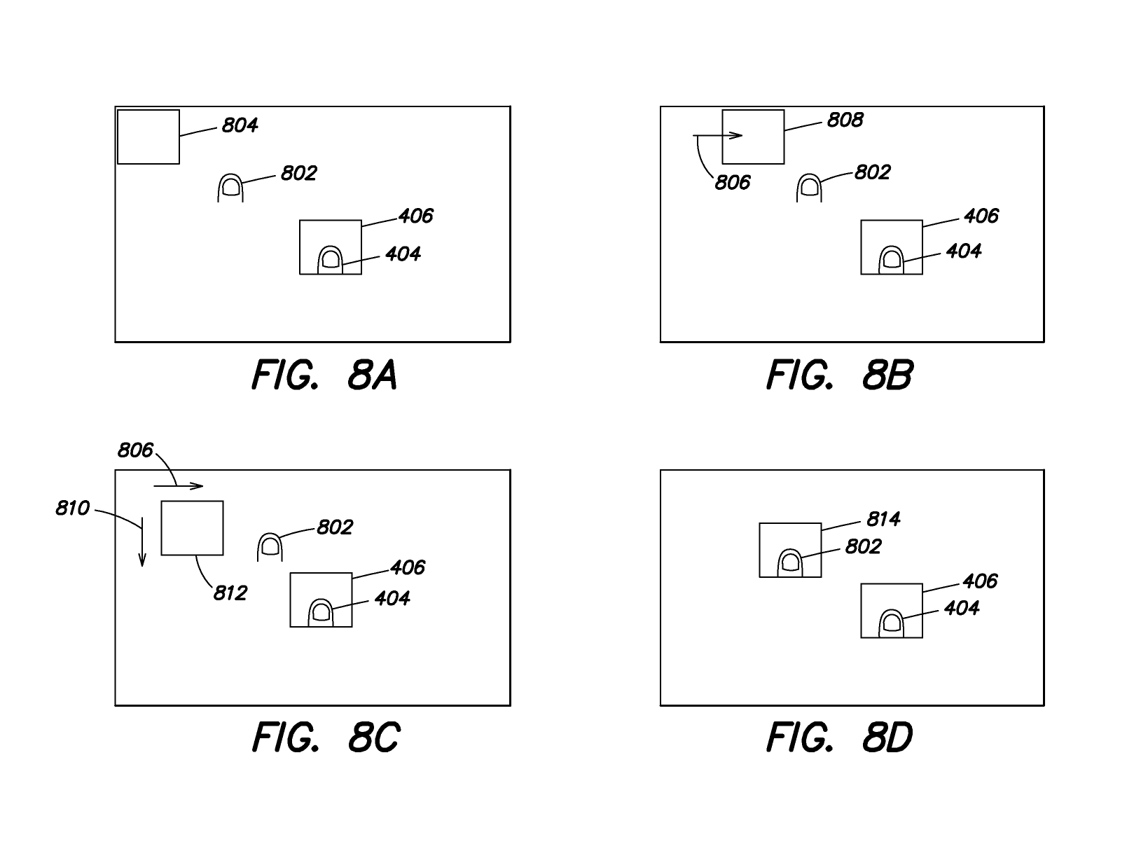

In some embodiments, each successive frame of a captured digital video stream can be scanned for the presence of a model object. To perform the scanning of each successive frame in a computationally and memory efficient manner, in some embodiments, the scanning of frames within a video stream can be performed in a raster pattern. In some embodiments, with each step of the raster scanning process, the contents of a test window are checked for the presence of an object that matches the model object. The process of checking contents of a test window can include operations described in more detail below, including edge detection on the test window contents, comparison of the number of edge pixels contained within a test window to the number of edge pixels within a model object edge image, comparison of the number of edge pixels contained within a test window to the number of edge pixels in the same test window from a previous frame, and distance metric calculations. An example of a raster scan for locating a match of a model object is illustrated in FIG. 8A-8D.

In FIG. 8A, a previously captured model object 404 can be located within the boundaries of the model target location 406 within the image 800 displayed on the display screen. A potentially matching object 802 is located within image 800. The matching object 802 may not be located initially within a test window 804 of the same size as the model target location 406. The raster scanning operation may proceed as shown in FIG. 8B, whereby a horizontal sliding operation 806 can be performed on the initial window 804 resulting in a new window location 808. In a preferred embodiment, the distance traversed by the test window during a raster sliding operation is less than the width of the test window itself. As shown in FIG. 8C, a vertical sliding operation 810 can also be performed, resulting in a test window location 812 that is offset from the starting location in both horizontal and vertical directions. In FIG. 8D, after a sufficient number of horizontal and vertical shifts of the sliding window, the test window 814 contains within its boundaries the object 802. Upon performing various test operations as described below, including edge detection, edge pixel counting, and distance metric calculations, a match can be determined for the presence of a copy of the model object within the current video frame.

By detecting the presence of an object matching the model object at any location within a succession of video frames, the system can associate the location of the matched object with gestures that have been performed by the user having a specific spatial relationship relative to the display device. The system can associate the identified gesture with operations to be performed that are relative to the context of the currently executing application.

In some embodiments, the association between identified gestures and computer operations to be performed might be operations that are contextual to the operating system. For example, the operating system may associate the continuous tracking of matches of a model object within successive video frames as controls for a pointer displayed on a display screen. In this context, the movement of a tracked object controls the displayed pointer in a manner similar to how movement of a computer mouse is traditionally used to control movement of a pointer within a graphical user interface. In some embodiments, detecting a stationary position for an object matching a model object may be interpreted as a selection gesture, as often traditionally associated with clicking the button on a computer mouse.

In some embodiments, the operation associated with the tracking of an object and identification of a gesture may be associated with an application specific context. For example, if the currently executing application displayed on the display screen is a photo album application, then a swipe gesture may be detected by the system and represented on the screen as a page turn, a page flip, a scroll, or any number of other dynamic updates to the display. In another example, if the currently executing application is a video game, the detection of a swipe gesture performed by the end user may cause a character in the video game to perform an in-game action, such as swinging a bat or a sword. Other example applications where the detection of successive gestures might be integrated include the interpretation sign language, such as American Sign Language or other dialects of sign language, detection of movements associated with music conduction, such as orchestral or choral conductor training applications, as well as other possible applications.

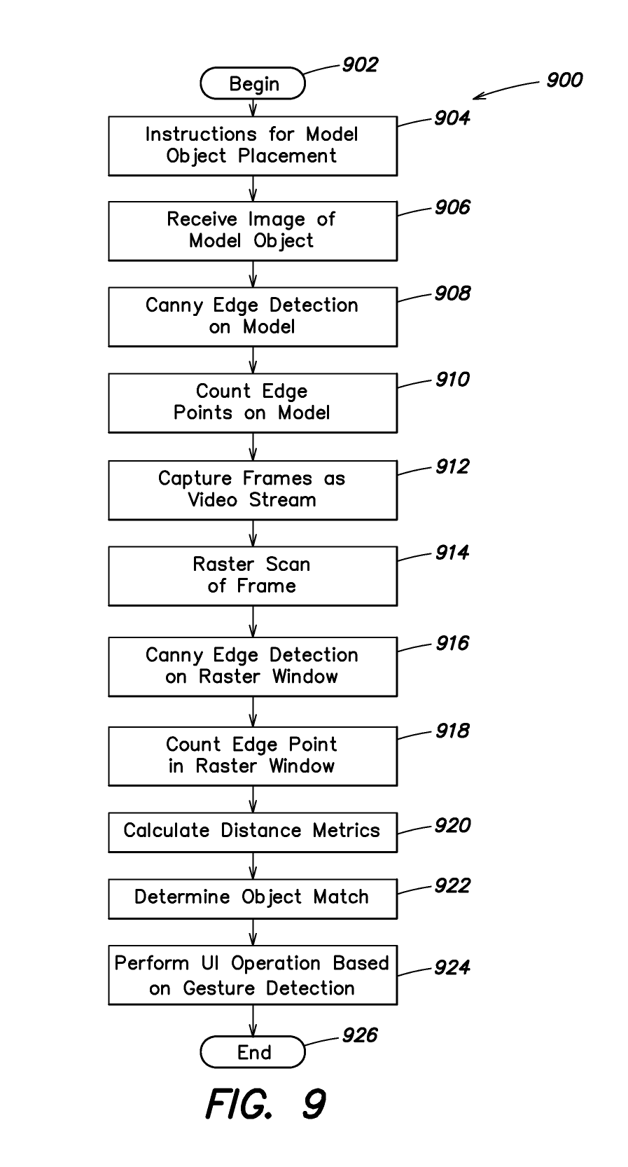

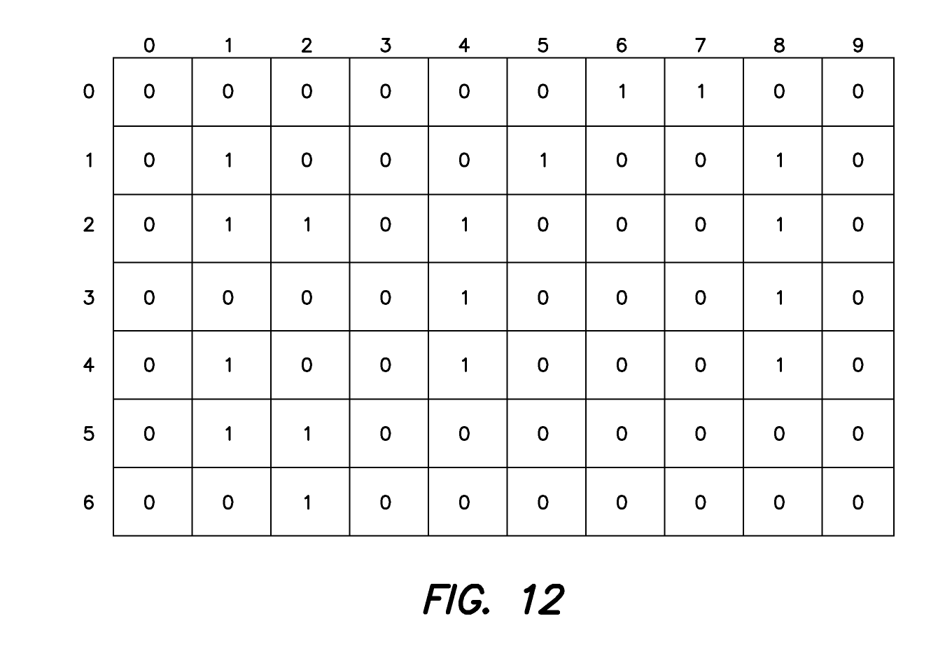

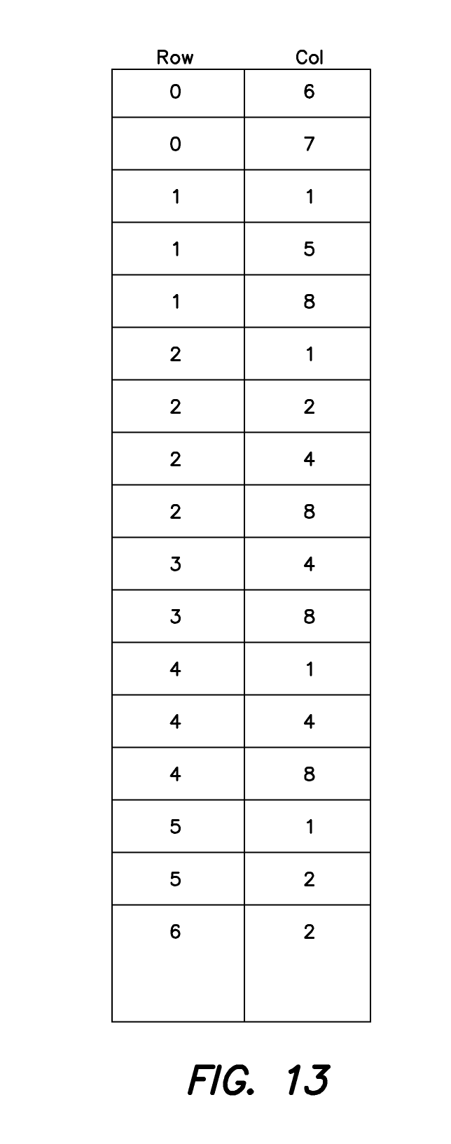

FIG. 9 describes a process for capturing a digital image of a model object from a stream of video frames, comparing that model object with the contents of a later image to identify the model's new location, and then executing a user interface command based on recognition of the model object in a new location. Process 900 begins at step 902. In act 904, the system instructs the user to place an object to be used as a model, such as the user's finger, within the boundaries of a target location in the field of view of the mobile computing device's native camera. In act 906, the system receives the image of the model object and stores a copy of the image containing the model object either in random access memory or in permanent storage. In some embodiments, the action prompting the native camera to capture the image may consist of pressing a virtual button on the display screen, timing the presence of a detected object at a particular location, executing a voice command received by a microphone and interpreted by the central processor, a vibrational action, such as a bump or a shake, or other mechanical human-computer interaction. In some embodiments, acts 904 and 906 may not be required to be performed. In certain embodiments, the system may utilize a pre-stored model object within a model object database. In other embodiments, the system may perform real-time object recognition through the execution of rules relating to detected shapes and relationships between geometric forms as defining the model object. In act 908, a modified Canny edge detection operation, as described in more detail below with reference to FIG. 9, is performed on the image containing the model object 404 to identify the salient edge features of the model object 404 within the image of the initial target location 406. In act 910, the number of edge points can be calculated within the image containing the model object. In some embodiments, upon calculating the number of edge points within the image containing the model object, the edge point locations can be stored in a densely packed form by row and column location as described in more detail below in reference to FIG. 12 and FIG. 13.

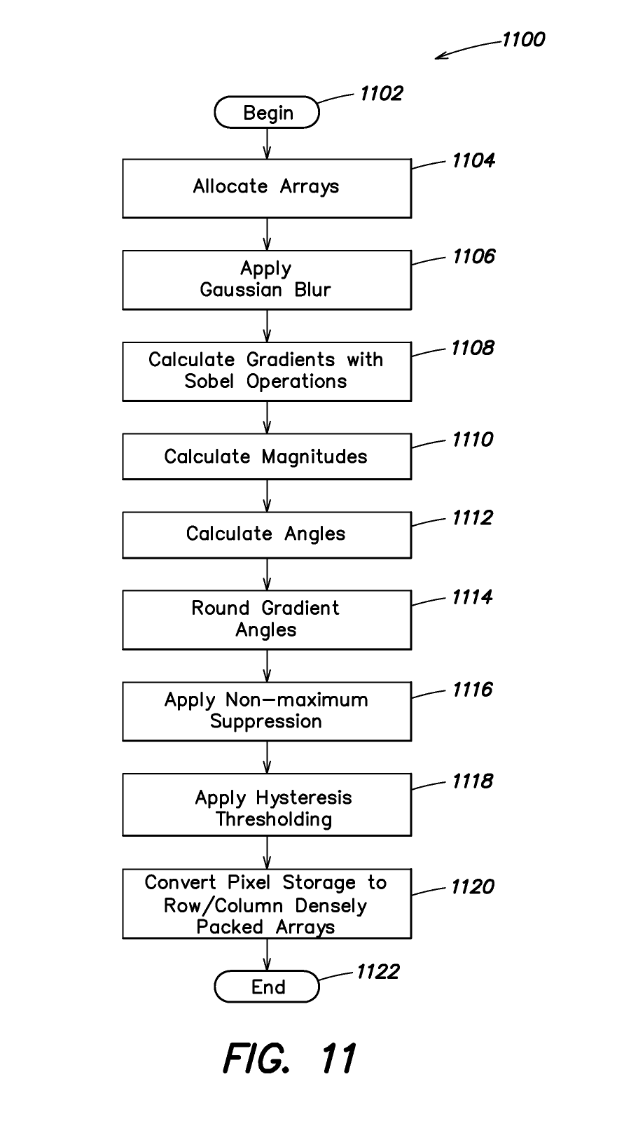

In act 912, a series of image frames may be captured by the camera as a video stream. As each frame is captured, the associated image is retained in random access memory or permanent storage. In act 914, as each frame of the video stream is obtained, a raster scan of the current video frame may be performed using a window that is of the same size as the model object image. In act 916, as each step in the raster scan is performed, a modified Canny edge detection operation is performed on the captured images to obtain edge images associated with the frames of the video stream. In act 918, at each step of the raster scan, a count of the edge pixels present within the current window may be performed. In some embodiments, upon calculating the number of edge points containing the model object, the edge point locations can be stored in a densely packed form by row and column location as described in more detail below in reference to FIG. 12 and FIG. 13. In further embodiments, if the number of edge pixels within the current window is within predefined limits, e.g. within plus or minus thirty-percent, of the number of edge pixels counted in the model object image, then the process may proceed to check for the presence of a matching object within the current window. In other embodiments, if the number of edge pixels is within predefined limits compared to the number of edges in the same test window from a previous frame, then the process may proceed to check for the presence of a matching object within the current window. If the number of edge pixels is not within the predefined limits, then the raster scan may proceed by sliding the window a specific number of pixels, and repeats the edge pixel count comparison. In some embodiments, the raster scan may be terminated early when appropriate conditions are met for the matching of an object. By terminating the raster scan based on the presence of appropriate conditions, as discussed in more detail below in relation to FIG. 11, significant performance improvements for the overall process of object recognition and object tracking may be obtained.

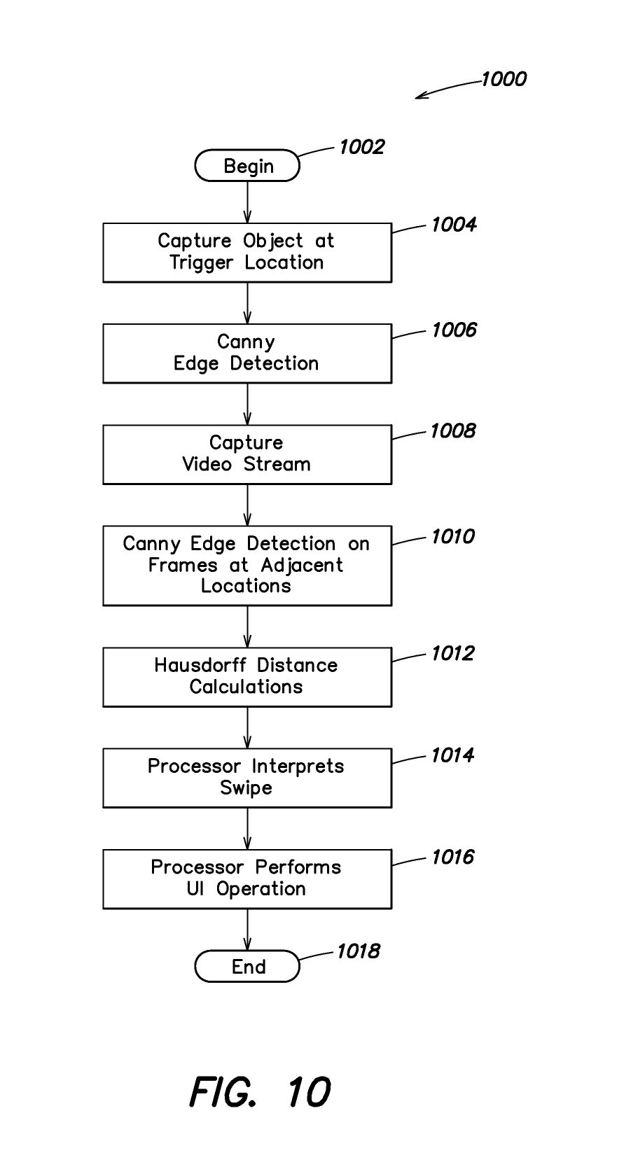

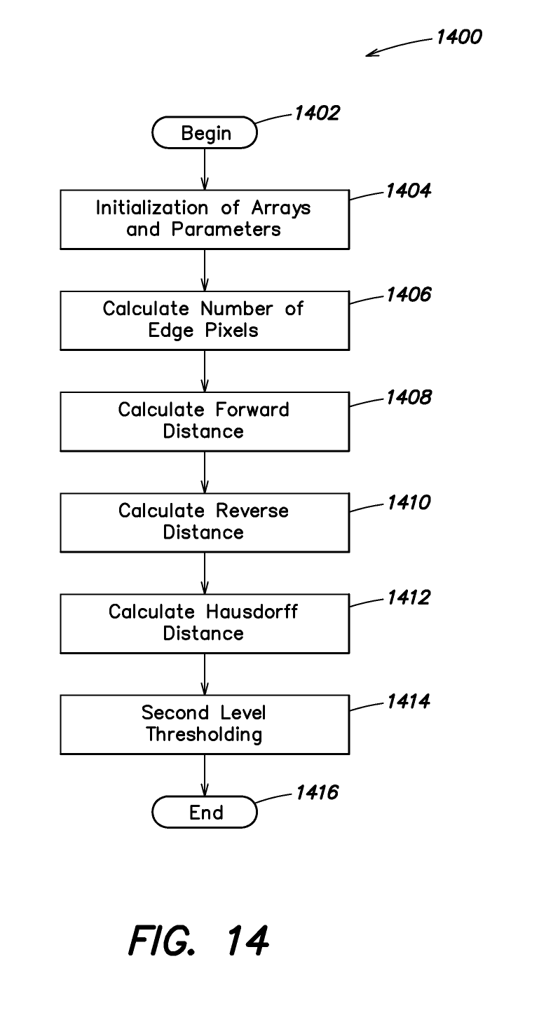

In act 920, if the number of edge pixels within the current window is within the predefined limit boundaries, then a set of distance metrics may be calculated. Possible distance metrics calculated include a forward distance, a reverse distance, and a modified Hausdorff distance metric described in more detail below. These metrics may be calculated between the edge image of the model object, and the edge point sets contained within test windows of a raster scan for frames of a captured video stream. Discussion of the calculated distance metrics are discussed below in relation to FIG. 14. In act 922, upon calculating the appropriate distance metrics for the edge point sets within test windows of raster scans for video frames, a determination may be made regarding if or where an object matching the model object is present. In act 924, based on the determination of a matched object in a particular image of the video stream or a series of consecutive images in the video stream, the central processor determines that a gesture has been performed, and associates that gesture with an operation to be performed within the application currently being executed. Example operations to which the detection of a static object might be associated include movement of a pointer, selection of an item from a menu of items displayed on-screen, the pressing of a virtual button, or other operations specific to a particular application. Method 900 ends at act 926. The method described in relation to FIG. 9 describes the detection of a target object at a single point in space in relation to a model target object. In some embodiments, as described in the method illustrated in FIG. 10, a method is described enabling the detection of a target object in motion with reference to a trigger location. As illustrated in FIG. 10, method 1000 begins with act 1002. In act 1004, the system captures a model image of an object in a particular trigger location, such as model object 704 in trigger location 702 of FIG. 7. In act 1006, a modified Canny edge detection operation, as described more fully below, is executed to determine the edge locations of the model object. In act 1008, subsequent images are captured as part of a video stream of images. In act 1010, a modified Canny edge detection operation is performed on the images captured in the video stream, but is limited to only those areas of the image adjacent to the original target trigger location. For example, with regards to FIG. 7, a model object 704 is previously captured within a trigger location 702. After capturing the model image, observation is made of adjacent locations 706, 708 and 710. A modified Canny edge detection process is executed to determine the edges of any objects present within the locations adjacent to the trigger location. In act 1012, distance metric calculations, such as the modified Hausdorff distance calculation described below, can be performed on adjacent locations 706, 708 and 710 to determine a match. In act 1014, the presence of matched objects detected within the trigger location and adjacent locations can be recognized by the processor as a swipe action that was performed by the user at a particular physical location in relation to the display screen. In act 1016, the processor can associate the detected swipe action with an operation to be performed within the currently executing application. Method 1000 ends with act 1018.

Modified Canny Edge Detection

The well-known Canny edge detection algorithm is a method of determining the location of edges within a digital image first developed by John F. Canny, and later improved upon in the well-known Canny-Deriche edge detection algorithm developed by Rachid Deriche. In the context of the present invention as implemented in one embodiment, a modified version of the Canny process may be used as shown in FIG. 11. Method 1100 begins with act 1102. In act 1104, appropriate random access memory or permanent data storage needed for the following steps is allocated for later use by the operating system as part of the modified Canny edge detection process. In act 1106, a Gaussian blur operation is performed by creating a Gaussian filter matrix and convolving that matrix with the digital image of interest. In act 1108, gradient operations for the horizontal and vertical directions are performed by convolving the current blurred image with gradient filter operators for the horizontal and vertical directions. In act 1110, the magnitude of the gradient image is determined by calculating the element-wise L₂-norm of the gradient images.

In act 1112, the edge detection angle is determined for each point in the image by calculating the element-wise inverse tangent of the ratio between the vertical gradient image and the horizontal gradient image. In act 1114, the element-wise edge detection angle array is rounded to angles representing vertical, horizontal and two diagonal angles at 0, +45, −45, +90, −90, +135, −135, +180, and −180 degrees. In act 1116, a non-maximum suppression operation is applied element-wise to members of the resulting array of rounded angles. If a rounded gradient angle is 0, +180, or −180 degrees, then the point is considered to be an edge only if its gradient magnitude is greater than pixels in the east and west directions. If a rounded gradient angle is +90 or −90 degrees, then the point is considered to be an edge only if its gradient magnitude is greater than pixels in the north and south directions. If a rounded gradient angle is −45 or 135 degrees, then the point is considered to be an edge only if its gradient magnitude is greater than pixels in the northwest and southeast directions. If a rounded gradient angle is 45 or −135 degrees, then the point is considered to be an edge only if its gradient magnitude is greater than pixels in the northeast and southwest directions. Upon completing the non-maximum suppression operation, a sparsely-filled dense array is created containing binary values representing edge locations and non-edge locations, such as the array shown in FIG. 12. In act 1118, a hysteresis threshold operation is performed to determine whether particular detected edge points should actually be considered part of an edge. In some embodiments, the upper and lower threshold limits of the hysteresis threshold operation can be set dynamically based on the luminance detected in the original image. After completing the hysteresis threshold operation, the edges within a particular image are determined. In act 1120, the non-zero locations of the edge point locations are stored by their row and column values in two separate arrays as shown in FIG. 13 for the original edge array of FIG. 12. Process 1100 ends with act 1122.

Modified Hausdorff Distance Calculation

The calculation of a Hausdorff distance metric may be used for determining the presence and location of a model target object within a captured digital image. The process for determining the Hausdorff distance between the edges of a target model object and objects within a separately captured image are described in relation to FIG. 14. The process 1400 begins with act 1402. In act 1404, array initializations within computer random access memory or permanent data storage required for the subsequent process steps are allocated. In act 1406, a calculation of the number of edge pixels present within the current image are performed. The current image could be either the model object image or any test window of the raster scanning process described previously. In act 1406, dense arrays of edge locations are created. These dense arrays consist of the edge location points for an object created in a manner as described previously in act 1118 of FIG. 11.

In act 1408, the forward distance is calculated between the edges of the model object and the edges of the later captured image. For two sets of points X and Y, the forward distance between set X and set Y is the least upper bound of all elements in X of the greatest lower bound of all elements of Y of the distance between each pairwise element distances of points in X and Y. For a model object X and an image Y, the forward distance is the maximum distance between any point in the model object and any point in the image. Stated differently, the minimum distance is found between a particular model object point and all image points. The process is repeated for all model object points. The forward distance is the maximum of those minimum distances.

In act 1410, the reverse distance is calculated between the edges of the later captured image and the model object. For two sets of points X and Y, the reverse distance between set Y and set X is the least upper bound of all elements in Y of the greatest lower bound of all elements of X of the distance between each pairwise element distances of points in X and Y. For a model object X and an image Y, the process of finding the reverse distance is the same as finding the forward distance, with the roles of the model object X and image Y reversed. The minimum distance is found between a particular point in the image Y and all model object points in X. The process is repeated for all image points in Y. The reverse distance is the maximum of those minimum distances. In act 1412, the Hausdorff distance may be calculated as the maximum of the forward distance and the reverse distance.

In act 1414, a second level thresholding can be performed providing performance optimization of the distance calculation process. Examples of second level thresholding might include determining if at least half of the edges in the array are within a predefined length of pixel separation of each other. For example, if all edge pixels are within 2 pixel lengths of each other, then an object identified within the later image can be determined to be a match. Other examples of second level thresholding may involve terminating the iterative calculations involved in performing the distance metric calculation process if appropriate conditions are met during the course of the distance metric calculations. In one example, if an intermediate iteration of the forward distance is calculated to have a value below a preset threshold, then the distance metric calculation process can exit with a positive match without iterating through all points in the set. One illustration would be a forward distance calculation with a value of zero that would imply complete overlap of the model object and the image. In a second example, when performing forward or reverse distance metric calculations, outlier points might be present that could contribute to false positives or result in missed true positives. In this example, a thresholding operation can be performed that counts the number of minimum distances between model edge pixels and image edge pixels and can trigger an exit from the process if the number of distance values calculated is above an acceptable threshold. In a third example of second level thresholding, as part of performing a Hausdorff distance metric calculation process, if whenever a new percentile of distances between the model object and the image can be found below a present distance threshold, signaling a potential match, then a new standard can be set such that all later distance metric calculations for other windows in the same frame must meet to result in a match. In this example, the thresholding operation can result in a faster time to progress through the entirety of the raster scan when searching for an image that matches the model object.

### Mobile Computing System

Referring to FIG. 15, the components of a mobile computing device 100 may include a central processor 1510, a graphics processor 1512, a memory 1514, a bus 1516, an interface 1518, data storage 1520, an accelerometer 1522, a gyroscope 1524, a battery 1526, a capacitive touch screen display 102, and a digital camera 104. The processor 1510 may be any type of processor, multiprocessor or controller. Some exemplary central processors include commercially available processors such as an Intel Xeon, Itanium, Core, Celeron, Pentium, or Atom processor, and AMD Opteron Processor, a Sun UltraSPARC, an ARM processor, an NVidia Tegra processor, or IBM Power5+ processor and an IBM mainframe chip. Examples of graphics processors include NVidia GeForce, Quadro, or Tesla, processors, Imagination Technologies' PowerVR processors, ARM Mali processors, or Intel HD graphics processor. The processor 1510 and graphics processor 1512 are connected to other system components, including one or more memory devices 1514, by the bus 1516. The memory 1514 may be a relatively high performance, volatile, random access memory such as a dynamic random access memory (DRAM) or static memory (SRAM). However, the memory 1514 may include any device for storing data, such as a disk drive or other nonvolatile storage device. Various examples may organize the memory 1514 into particularized and, in some cases, unique structures to perform the functions disclosed herein. The data structures may be sized and organized to store values for particular data and types of data.

The components of the mobile computer system 100 can be coupled by an interconnection element such as the bus 1516. The bus 1516 may include one or more physical busses, for example, busses between components that are integrated within a same machine, but may include any communication coupling between system elements including specialized or standard computing bus technologies such as IDE, SCSI, and PCI. The bus 1516 enables communications, such as data and instructions, to be exchanged between system components of the computer system 100.

The computer system 100 can also include one or more interface devices 1518 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 100 to exchange information and communicate with external entities such as users and other systems.

The data storage 1520 includes a computer readable and writeable nonvolatile, or non-transitory, data storage medium in which instructions are stored that define a program or other object that is executed by the central processor 1510 or graphics processor 1512. The data storage 1520 also may include information that is recorded, on or in, the medium, and that is processed by the central processor 1510 or graphics processor 1512 during execution of the program. More specifically, the information may be stored in one or more data structures specifically configured to conserve storage space or increase data exchange performance. The instructions may be persistently stored as encoded signals, and the instructions may cause the central processor 1510 or graphics processor 1512 to perform any of the functions described herein. The medium may, for example, be optical disk, magnetic disk or flash memory, among others. In operation, the central processor 1510, graphics processor 1512, or other controller causes data to be read from the nonvolatile recording medium into another memory, such as the memory 1514, that allows for faster access to the information by the central processor 1510 or graphics processor 1512 than does the storage medium included in the data storage 1520. The memory may be located in the data storage 1520 or in the memory 1514, however, the central processor 1510 or graphics processor 1512 manipulates the data within the memory, and then copies the data to the storage medium associated with the data storage 1520 after processing is completed. A variety of components may manage data movement between the storage medium and other memory elements and examples are not limited to particular data management components. Further, examples are not limited to a particular memory system or data storage system.

The accelerometer 1522 and gyroscope 1524 may be utilized to determine the acceleration and orientation of the computing device, and may send signals to the central processor 1510 or graphics processor 1512 to determine the orientation of any images to be displayed on the display screen 102. A battery 1526 embedded within the device may be utilized to provide electrical power to all components in the mobile computing device that require electrical power for operation. An embedded camera 104 may be utilized for capturing digital video and digital images. Video images can be sent to the central processor 1510 or graphics processor 1512 for digital image processing, can be maintained within memory 1514 for later processing, or archived in storage 1520.

Although the computer system 100 is shown by way of example as one type of computer system upon which various aspects and functions may be practiced, aspects and functions are not limited to being implemented on the computer system 100 as shown in FIG. 1 and FIG. 15. Various aspects and functions may be practiced on one or more computers having a different architectures or components than that shown in FIG. 1 and FIG. 15. For instance, the computer system 100 may include specially programmed, special-purpose hardware, such as an application-specific integrated circuit (ASIC) tailored to perform a particular operation disclosed herein.

The computer system 100 may be a computer system including an operating system that manages at least a portion of the hardware elements included in the computer system 100. In some examples, a processor or controller, such as the central processor 1510, executes an operating system. Examples of a particular operating system that may be executed include a Windows-based operating system, such as, Windows NT, Windows 2000 (Windows ME), Windows XP, Windows Vista, Windows 7, Windows 8, Windows RT, or Windows Phone operating systems, available from the Microsoft Corporation, a MAC OS X or iOS operating system available from Apple Computer, one of many Linux-based operating system distributions, for example, the Enterprise Linux operating system available from Red Hat Inc., Chrome or Android operating systems from Google, Inc., a Solaris operating system available from Oracle Corporation, or a UNIX operating systems available from various sources. Many other operating systems may be used, and examples are not limited to any particular operating system. In some embodiments, the computer system may consist of particular combinations of computer operating systems and hardware devices. For example, the computer system may include an iOS operating system executing on an iPhone, an iPad, iPad Mini, or iPod Touch from Apple Computer, or may include a version of the Windows Phone operating system executing on a device such as a Lumia device from Nokia Corporation, or may include a version of the Android operating system executing on mobile computing devices from various hardware vendors.

The processor 1510 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as Objective-C, .Net, SmallTalk, Java, C, C++, Ada, or C# (C-Sharp). Other object-oriented programming languages may also be used. Graphics programming libraries such as DirectX, OpenGL, or OpenGL for Embedded Systems (OpenGLES), as well as higher level libraries such as Apple Computer's Core Graphics Library (CGL) or Accelerate Framework, Microsoft Corporation's Windows Graphics Library (WGL) or the OpenGL extension to the X Window System (GLX), may also be used for programming the graphics processor 1512 to perform graphics operations.

Alternatively, functional, scripting, or logical programming languages may be used. Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the scope of the embodiments disclosed herein. Accordingly, the foregoing description and drawings are by way of example only.

What is claimed is:

1. A system for providing a gesture based user interface, the system comprising:
a memory;
at least one processor operatively connected to the memory;
a display device coupled to the at least one processor;
at least one native digital camera coupled to the at least one processor; and
an object tracking component executed by the at least one processor that can be configured to associate the tracking of objects with user interface operations.

2. The system of claim 1, wherein:
the at least one native digital camera can be configured to capture digital video; and
the captured digital video can be displayed with the center of the field of view captured by the at least one digital camera aligned to the center of the display device.

3. The system of claim 2, wherein the object tracking component is further configured to define a model object boundary location for display on the display device.

4. The system of claim 3, further comprising a training component configured to provide instruction to a user on placement of a model object in relation to the model object boundary location.

5. The system of claim 3, wherein the training component is configured to provide user instruction that a proper model object can be obtained by the native digital camera.

6. The system of claim 3, wherein the model object boundary location can be displayed on the display device simultaneously with the digital video.

7. The system of claim 3, wherein the object tracking component is configured to capture digital video data of a model object within the model object boundary location.

8. The system of claim 7, wherein the object tracking component is configured to define the model object from captured digital video data.

9. The system of claim 8, wherein the object tracking component is configured to identify the model object within successive video frames.

10. The system of claim 1, wherein the object tracking component is further configured to define a digital image of a model object and wherein the processor is further configured to perform edge detection on the digital image of the model object to obtain an edge image of the model object.

11. A method for performing computer user interface operations, the method comprising:
capturing a digital video;
displaying captured video on a display device;
identifying a model object within a first video frame;
tracking a model object by matching objects within successive video frames;
associating the location of a model object in successive video frames with a gesture;
associating a gesture with a user interface operation; and
executing a user interface operation.

12. The method of claim 11, wherein capturing the digital video further comprises the use of at least one native digital camera integrated into a computer to capture the digital video.

13. The method of claim 12, wherein displaying the captured digital video on the display device further comprises aligning the center of the captured video with the center of the display device.

14. The method of claim 13, wherein identifying a model object further comprises defining a model object boundary location for display on the display device.

15. The method of claim 14, wherein identifying the model object further comprises providing instruction to a user on placement of the model object in relation to the model object boundary location.

16. The method of claim 14, wherein identifying the model object further comprises displaying the model object on the display device simultaneously with the digital video.

17. The method of claim 14, wherein identifying the model object further comprises capturing digital video data of a model object within the model object boundary location.

18. The method of claim 17, wherein identifying the model object further comprises defining the model object from the captured digital video data.

19. The method of claim 11, wherein tracking the model object further comprises performing edge detection on the digital image of the model object to obtain an edge image of the model object.

20. The method of claim 19, wherein tracking the model object further comprises performing Canny edge detection on the digital image of the model object.
